(19) United States
(12) Patent Application Publication
(10) Pub. No.: US 2014/0149231 A1
(43) Pub. Date: May 29, 2014

(54) SYSTEM AND METHOD OF IMPOSING AND MANAGING PENALTY FOR BREACH OF ADVERTISING CONTRACT

(71) Applicant: NAVER BUSINESS PLATFORM CORPORATION, SEONGNAM-SI (KR)

(72) Inventors: Sang Mi Oh, Seongnam-si (KR); Sunggu Han, Seongnam-si (KR); Jae Young Chang, Seongnam-si (KR)

(73) Assignee: NAVER BUSINESS PLATFORM CORPORATION, SEONGNAM-SI (KR)

(21) Appl. No.: 14/090,468

(22) Filed: Nov. 26, 2013

(30) Foreign Application Priority Data
Nov. 26, 2012 (KR) 10-2012-0134640

(51) Int. Cl. G06Q 30/02

(52) U.S. Cl. CPC G06Q 30/0273
USPC 705/14.69

(57) ABSTRACT

A system for imposing and managing a penalty for a breach of an advertising contract includes a registration unit to register conditions of the advertising contract and penalty contents related to the conditions, a monitoring unit to monitor a fulfillment of the advertising contract in order to determine whether the penalty is to be applied, and a penalty unit to notify penalty contents related to the breach of the advertising contract when the breach of the advertising contract is recognized.

### CROSS-REFERENCE TO RELATED APPLICATION

This application claims priority from and the benefit of Korean Patent Application No. 10-2012-0134640, filed on Nov. 26, 2012, which is hereby incorporated by reference for all purposes as if fully set forth herein.

### BACKGROUND

1. Field

Example embodiments relate to a method and a system for imposing and managing a penalty for a breach of an advertising contract.

2. Description of the Background

In the case of contracting an advertisement, a variety of penalties, such as imposing a penal sum and limiting an advertisement reservation, for example, may be imposed for a breach of an advertising contract, such as unilaterally cancelling the advertising contract under contract.

FIG. 1 illustrates a process of registering and managing a penalty for a breach of contract according to a related art. A conventional method is not systematically performed and thus, a management is difficult and an error also occurs.

When a breach of an advertising contract occurs, a contract to be imposed with a penalty may be firmly determined by sharing information associated with the advertising contract corresponding to the breach and a penalty to be applied based on the breach using a mail or an email, and by monitoring a notification mail according to a substantial suspension of an advertisement.

The advertisement determined to be imposed with the penalty may be processed by delivering, to an advertiser having made the advertising contract, matters related to the details of the breach and penalty contents through an official document. On a side of an advertising firm, such contract to be imposed with a penalty may be written and managed as a document in a form of a word file or an excel file. A list of cases corresponding to a breach of contract per month or per year may be prepared and be transferred to a person in charge within the advertisement firm. The person in charge may manually register the transferred list of cases to an enterprise resource planning (ERP) system and thereby systematically manage the list of cases.

The aforementioned method requires a process that is performed by a person. Thus, a case is likely to be omitted in tracking during a process of managing cases to be imposed with a penalty for a breach of contract. In addition, the cases to be imposed with the penalty may not be systematically registered and managed and thus, difficulty may arise in managing a current status.

Further, in a case in which a penalty for a breach of contract is imposed as a penal sum, interaction with the ERP system may not be performed and thus, communication cost may be required. Accordingly, a transparency issue may arise in terms of managing the penal sum.

Accordingly, there is a need for a management system and method that can surely monitor and verify cases corresponding to a breach of an advertising contract, which are cases to be imposed with a penalty.

### SUMMARY

Example embodiments provide a system and a method that surely manage and verify cases corresponding to a breach of an advertising contract, which are cases to be imposed with a penalty.

Example embodiments also provide a system and method that enables an advertiser having made a contract to be well informed of the conditions in which a penalty for a breach of contract is to be imposed and the result of applying the penalty.

Example embodiments also provide a system and a method that register and store, in a system, matters related to an occurrence of a penalty and an imposition of the penalty, and thereby makes it possible to refer to the registered matters in a case in which the breach of contract occurs.

Example embodiments also provide a system and a method that automatically interact with an enterprise resource planning (ERP) system in a case in which a penalty for a breach of contract is imposed as a penal sum, and thereby preventing a transparency issue from arising in terms of managing the penal sum.

Additional features of the example embodiments will be set forth in the description which follows, and in part will be apparent from the description, or may be learned by practice of the example embodiments.

Example embodiments disclose a system for imposing and managing a penalty for a breach of an advertising contract, the system including a registration unit to register conditions of the advertising contract and penalty contents related to the conditions, a monitoring unit to monitor a fulfillment of the advertising contract in order to determine whether the penalty is to be applied, and a penalty unit to notify penalty contents related to the breach of the advertising contract when the breach of the advertising contract is recognized.

The registration unit registers basic conditions of which the penalty is applied and weighted conditions of which the penalty is weighted, and stores the history of the basic conditions and the weighted conditions in a database.

The monitoring unit monitors whether the penalty is to be applied in response to a request for cancelling the advertising contract, and automatically notifies a user of the system about a presence of conditions of which the penalty is to be applied on the basis.

The penalty unit determines whether the penalty contents are to be applied, and notifies an advertiser of the advertising contract about an imposition of the penalty.

The penalty unit may limit an advertisement reservation in a case in which the penalty contents relate to limiting a subsequent advertisement publication, and may interact with an ERP system in a case in which the penalty contents relate to a payment of a penal sum of the advertising contract.

The penalty imposition and management system may further include a management and reference unit to manage and refer to the conditions of the advertising contract and the penalty contents. The management and reference unit may receive an input for modifying and cancelling the penalty contents related to the breach of the advertising contract.

Example embodiments also disclose a method of imposing and managing a penalty for a breach of an advertising contract, the method including registering conditions of the advertising contract and penalty contents related to the conditions, monitoring a fulfillment of the advertising contract in order to determine whether the penalty is to be applied, and notifying penalty contents related to the breach of the advertising contract when the breach of the advertising contract is recognized.

The penalty imposition and management method may further include managing and referring to the conditions of the advertising contract and the penalty contents. The managing and referring to may include receiving an input for modifying the penalty contents related to the breach of the advertising contract and making a cancelation.

It is to be understood that both the foregoing general description and the following detailed description are explanatory and are intended to provide further explanation of the example embodiments as claimed.

### BRIEF DESCRIPTION OF THE DRAWINGS

The accompanying drawings, which are included to provide further understanding of the example embodiments and are incorporated in and constitute a part of this specification, illustrate example embodiments, and together with the description serve to explain the principles of the example embodiments.

FIG. 1 is a diagram illustrating a process of registering and managing a penalty for a breach of contract according to a related art.

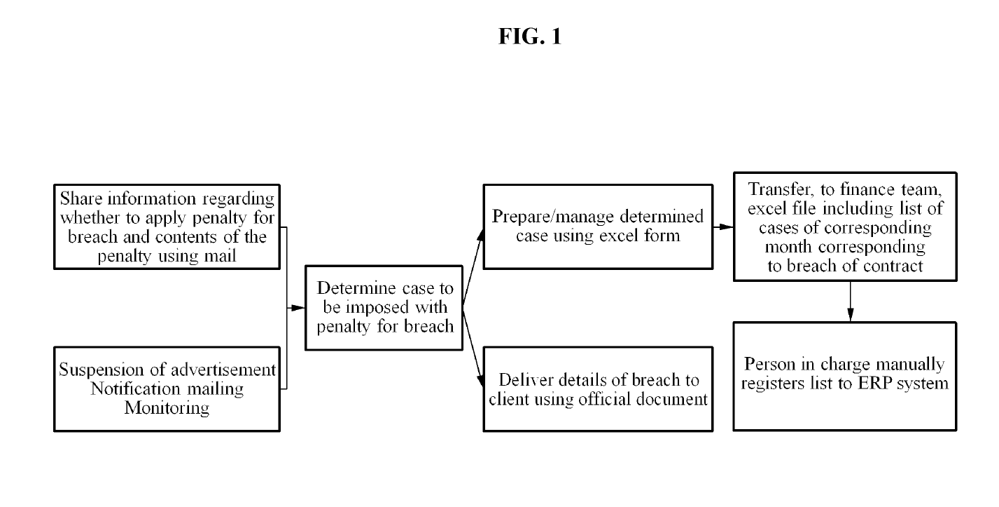

FIG. 2 is a diagram illustrating a relationship among an advertiser, an advertisement platform, a publisher, and a user according to an example embodiment.

FIG. 3 is a block diagram illustrating a configuration of a system for imposing and managing a penalty for a breach of an advertising contract according to an example embodiment.

FIG. 4 illustrates an example of contract contents capable of being registered in a system for imposing and managing a penalty according to an example embodiment.

FIG. 5 illustrates another example of contract contents capable of being registered in a system for imposing and managing a penalty.

FIG. 6 is a flowchart illustrating a method of imposing and managing a penalty for a breach of an advertising contract according to an example embodiment.

FIG. 7 is a flowchart illustrating an example of an operation of determining contents of a penalty for a breach of contract to be imposed on a target contract and whether the penalty is to be applied according to an example embodiment.

FIG. 8 is a flowchart illustrating another example of an operation of determining contents of a penalty for a breach of contract to be imposed on a target contract and whether to apply the penalty.

### DETAILED DESCRIPTION OF EXAMPLE EMBODIMENTS

The invention is described more fully hereinafter with reference to the accompanying drawings, in which example embodiments are shown. This invention may, however, be embodied in many different forms and should not be construed as limited to the example embodiments set forth herein. Rather, these example embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the conditions “first”, “second”, etc. may be used herein to describe various elements, components, regions, layers and/or sections, these elements, components, regions, layers and/or sections should not be limited by these conditions. These conditions are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative conditions, such as “beneath,” “below,” “lower,” “above,” “upper” and the like, may be used herein for ease of description to describe one element or feature's relationship to another element(s) or feature(s) as illustrated in the figures. It will be understood that the spatially relative conditions are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the conditions “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

Unless otherwise defined, all conditions (including technical and scientific conditions) used herein have the same meaning as commonly understood by one of ordinary skill in the art to which example embodiments belong. It will be further understood that conditions, such as those defined in commonly-used dictionaries, should be interpreted as having a meaning that is consistent with their meaning in the context of the relevant art and will not be interpreted in an idealized or overly formal sense unless expressly so defined herein.

Hereinafter, a system and method for imposing and managing a penalty for a breach of an advertising contract will be described with reference to the accompanying drawings.

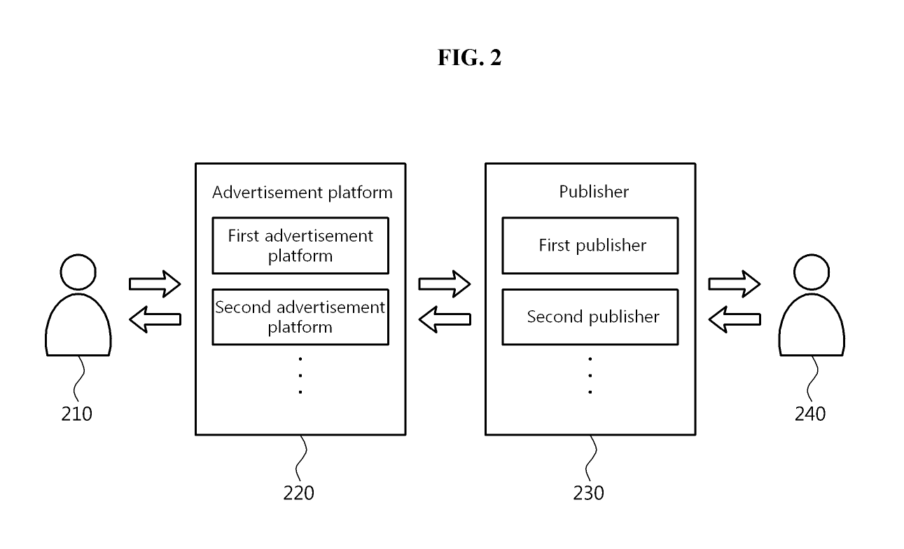

FIG. 2 is a diagram illustrating a relationship among an advertiser 210, an advertisement platform 220, a publisher 230, and a user 240 according to an example embodiment.

Referring to FIG. 2, each of the advertiser 210 and the user 240 may refer to a user terminal, for example, a personal computer (PC) or a server, or a mobile device such as a smart phone. The user terminal may be used by the advertiser 210 or the user 240. Arrows of FIG. 2 indicate that data may be transmitted and received between a user terminal used by the advertiser 210 and the user terminals used by the advertisement platform 220, the publisher 230, and the user 240 over a wired/wireless network.

The advertisement platform 220 may refer to an Internet-accessible computing system for performing bidding on an advertisement of the advertiser 210, matching an advertisement with a keyword, sorting advertisements or advertisers, providing an advertisement to the publisher 230, charging for displaying an advertisement, and the like. With respect to general technical aspects of the advertisement platform 220, description aspects construable with reference to related arts of a search advertisement and/or a banner advertisement platform delivered through the Internet is omitted.

In the present specification, the term “publisher” may be interchangeably used with the term “site”. However, description using the term “site” is not to be constructed as excluding a probability that the example embodiments may be carried out in an unusual website connection such as an application screen executed on a mobile terminal, for example, an environment in which a web site access of a general PC is not performed. Here, the “site” may include a type of a website on a computer or data network such as the Internet through which an advertisement may be displayed. The site may be provided to a user over a wired or wireless network. The site may include a single webpage configuring a website.

Referring to FIG. 2, the publisher 230 may provide a site of the publisher 230 to the user 240, and may provide one or more pages included in the site to the user 240 through the site, or may provide a search result associated with a keyword to the user 240 in response to the keyword input through the site. Here, the publisher 230 may receive, from the advertisement platform 220, one or more advertisements to be displayed through pages and provide the received advertisements to the user 240. For example, the publisher 230 may transfer a keyword input from the user 240 to the advertisement platform 220, and may receive an advertisement associated with the keyword from the advertisement platform 220 and provide the advertisement to the user 240 as a search result. As another example, the publisher 230 may determine an advertisement to be provided as a search result in response to a keyword input from the user 240, and may request the advertisement platform 220 for information about the determined advertisement. The publisher 230 may add, to the search result, information about the advertisement that is received from the advertisement platform 220, and may provide the search result to the user 240.

According to other example embodiments, an individual advertisement platform and an individual publisher may refer to systems included in a single system.

In the case of an advertisement provided according to the example embodiments described above, a substantial advertising contract is made between the advertiser 210 and the advertisement platform 220. When a breach of the advertising contract occurs, a penalty needs to be imposed. For example, when the advertiser 210 violates the conditions of the advertising contract, the advertiser 210 pays a penal sum to the advertisement platform 220. On the contrary, when the advertisement platform 220 violates conditions of the contract, the advertisement platform 220 pays a penal sum to the advertiser 210.

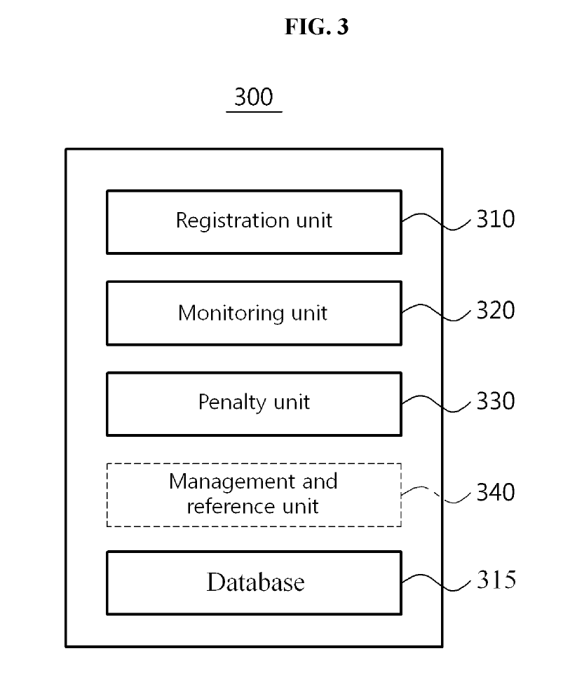

FIG. 3 is a block diagram illustrating a configuration of a penalty imposition and management system 300 for imposing and managing a penalty for a breach of an advertising contract according to an example embodiment. The penalty imposition and management system 300 may be a computing system included in the aforementioned individual advertisement platform 220 or the individual publisher 230, or may be a separate computing system such as a personal computer or a server associated, and in wired/wireless communication, with the individual advertisement platform or the individual publisher.

Referring to FIG. 3, the penalty imposition and management system 300 includes a registration unit 310, a monitoring unit 320, and a penalty unit 330. The penalty imposition and management system 300 may further include a management and reference unit 340 depending on example embodiments. The penalty imposition and management system 300 registers the conditions of a penalty for a breach of contract specified in contracting an advertisement based on an advertisement sales policy, monitors target contracts, imposes a penalty for a breach of contract, and manages a history of the corresponding contract and penalty.

The registration unit 310 registers the definitions and conditions of a target advertising contract to be imposed with a penalty for a breach of contract, penalty contents related to the conditions, and the like. The contents registered by the registration unit 310 may be input using texts, for example, English and Korean, and numbers and thereby be identified in the penalty imposition and management system 300. Alternatively, the contents may be prepared by referring to pre-registered contents, for example, previous advertising contracts and thereby be identified in the penalty imposition and management system 300.

The conditions of the penalty registered by the registration unit 310 may be stored in a database 315 and be used to refer to and manage a history of the penalty within the penalty imposition and management system 300. Further, the conditions may be classified into basic conditions and weighted conditions and then be registered.

For example, a case in which a penal sum occurs due to a notification of an advertiser unilaterally cancelling an advertising contract may be registered as basic conditions. A case in which an advertiser unilaterally cancels an advertising contract at least twice may be registered as weighted conditions. In this case, a weighted penalty may be imposed so that the corresponding advertiser may not make an advertising contract with a corresponding advertisement platform during a predetermined period of time by setting a limit on the advertiser making an advertising contract during the predetermined period of time in addition to imposing a penalty. Also, it is possible to store a history associated with the weighted penalty in the database 315 of the registration unit 310, thereby enabling the stored history to be referred to and managed.

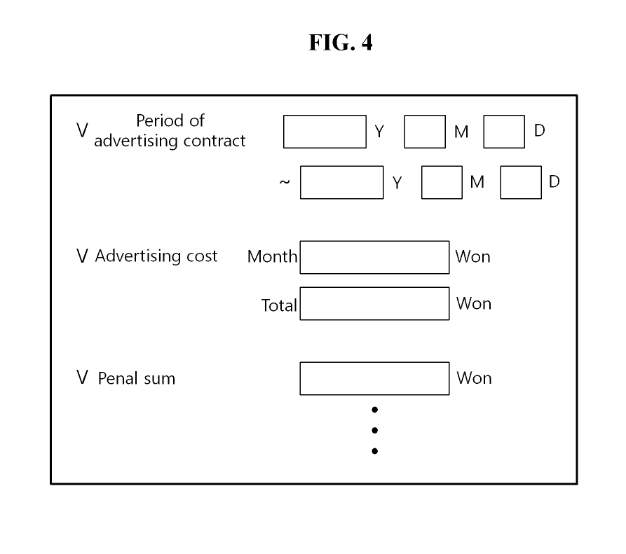

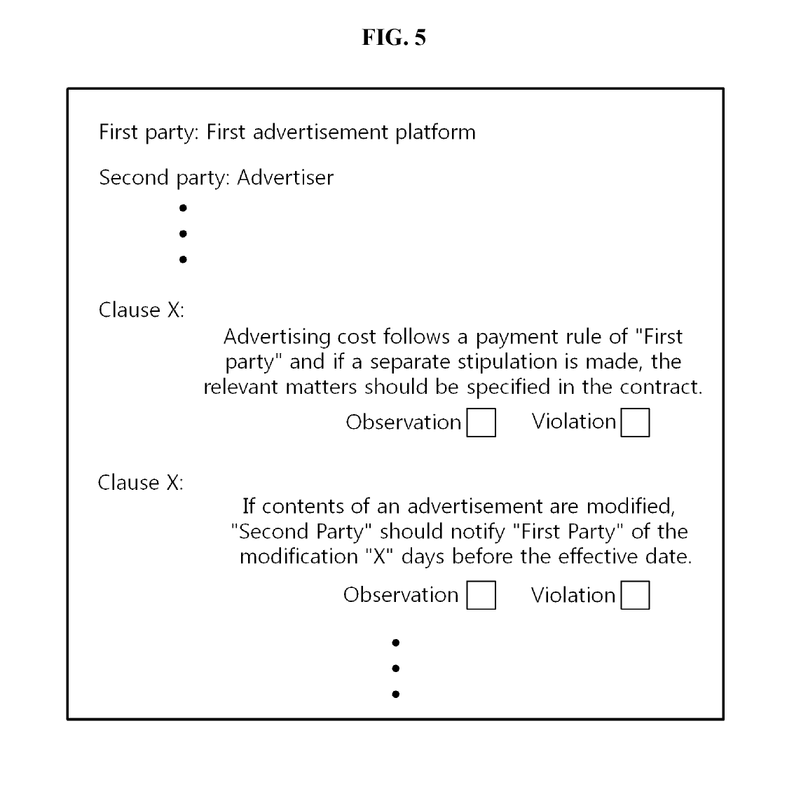

The above example embodiments will be further described with reference to FIGS. 4 and 5. FIG. 4 illustrates an example of an advertising contract registered by the registration unit 310. As illustrated in FIG. 4, “period of advertising contract”, “advertising cost” to be paid during the “period of advertising contract”, and a “penal sum” according to cancellation of the advertising contract may be described in the advertising contract.

The contents of the advertising contract of FIG. 4 are stored in a predetermined format of the registration unit 310. Therefore, by filling out empty fields in the format, the contents of the advertising contract may be stored in the database 315 as data capable of being referred to and managed. Contents related to a penal sum are stored as a penalty. The penal sum may be configured to decrease by a predetermined amount based on a monthly unit or a daily unit with respect to the entire period of the advertising contract.

FIG. 5 illustrates an example of an advertising contract stored as a text according to one example embodiment. As illustrated in FIG. 5, a written contract may be stored in the penalty imposition and management system 300 through the registration unit 310. The written contract may be formatted and thereby be modified based on an advertiser desiring to make a contract. Accordingly, a predetermined text of the written contract of FIG. 5 may be modified and be stored as an advertising contract made between an advertiser and an advertisement platform. Also, the full text of a written advertising contract may be newly input.

In the example of FIG. 5, penalty contents related to each clause may also be stored. A fulfillment of the written contract of FIGS. 4 and 5 may be monitored through the monitoring unit 320.

The monitoring unit 320 may monitor the fulfillment of the advertising contract and thereby determine whether a penalty for a breach of contract is to be applied. The monitoring unit 320 may monitor whether condition predetermined according to the advertising contract is to be satisfied through a computer network to verify the fulfillment of the advertising contract in real time. And, in response to a request for cancelling the advertising contract, the monitoring unit 320 may determine whether the penalty is to be applied, by monitoring violations associated with basic conditions and weighted conditions. The request may be input by a manager of the penalty imposition and management system 300 according to the advertiser's request, or may be received in the penalty imposition and management system 300 through advertiser page provided to the advertiser.

Here, when the breach of contract is found, a notification notifying an imposition of the penalty is transferred to the advertiser 210 and the advertisement platform 220. For example, when the notification is automatically transferred from the penalty imposition and management system 300 using an email or a short messaging service (SMS), contents related to the advertiser's cancellation of the advertising contract may also be transferred. Further, according to an example embodiment, a probable occurrence of a breach of contract may also be prevented by briefly notifying the advertiser 210 of the above contents when the advertiser transfers a request for cancelling the advertising contract.

In the case of storing the written advertising contract of FIG. 4, in response to the corresponding advertiser cancelling the advertising contract, a penal sum may be calculated based on days during which the advertising contract has been fulfilled and the like. Contents related to the calculated penal sum may be transferred to the advertiser. In the case of modifying and thereby storing only a text of the written advertising contract of FIG. 5 that is stored in the penalty imposition and management system 300, penalty contents related to a breach of contract may be modified in real time or in response to the advertiser cancelling the advertising contract, and a penalty may be imposed based on the modified penalty contents. For example, on the basis of a clause disclosed in a lower portion of FIG. 5 and saying “If contents of an advertisement are modified, ‘Second Party’ should notify ‘First Party’ of the modification ‘X’ days before the effective date”, if the advertiser violates the above clause by modifying the contents of the advertisement without giving any notice to the advertisement platform 220, or if the advertiser fails to notify the advertisement platform before the disclosed reference date, the penalty imposition and management system 300 may recognize the violations of the related clause using the monitoring unit 320 and impose a penalty on the advertiser.

Alternatively, through a manual input of violations with respect to clauses unidentifiable by the penalty imposition and management system 300, the penalty imposition and management system 300 may recognize the manual input and thereby impose a penalty.

The penalty imposition and management system 300 includes the penalty unit 330 to notify penalty contents related to the breach of advertising contract and to impose the penalty when the breach of advertising contract is recognized. The penalty unit 330 imposes the penalty with respect to a target contract that is to be imposed with the penalty, and transfers the contents of the penalty to an advertiser of the corresponding advertisement through an email or an SMS.

Whether to apply basic conditions or weighted conditions of which the penalty is applied on the basis may be determined. Accordingly, contents related to the corresponding conditions and penalty contents according to the conditions may be transferred to the advertiser. According to an example embodiment, if the penalty contents relate to limiting an advertisement reservation during a predetermined period of time, it is possible to set a limit on the corresponding advertiser using an advertisement reservation system in interaction with the advertisement reservation system. Further, if the penalty contents relate to a payment of a penal sum, details of the penal sum may be further efficiently managed in interaction with an ERP system.

The advertisement reservation system and the ERP system may be systems included in the individual advertisement platform 220 or the individual publisher 230, or may be separate systems associated with the individual advertisement platform or the individual publisher.

Also, the penalty imposition and management system 300 may include the management and reference unit 340 in order to refer to and manage information and details about a contract to which a penalty is imposed, penalty information, and details thereof. When erroneously stored contents or unnecessary contents are included in the details, the management and reference unit 340 receives an instruction for correcting or deleting the corresponding contents from the manager of the penalty imposition and management system 300 and then performs or cancels the instruction. Contents managed and referred to may be contents that are registered by the registration unit 310 and thereby stored in the database 315.

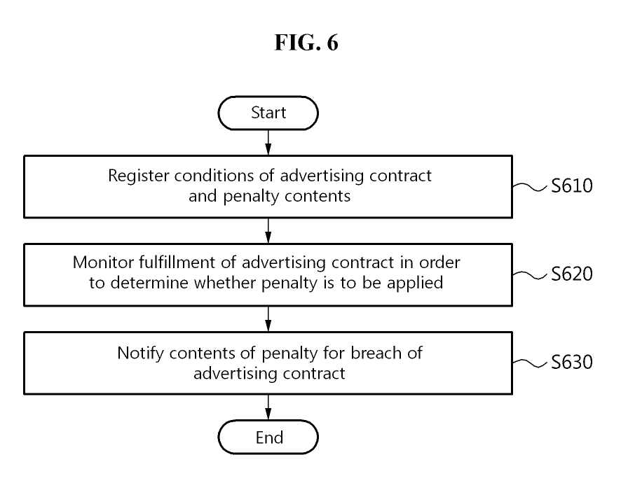

FIG. 6 is a flowchart illustrating a method of imposing and managing a penalty for a breach of an advertising contract according to one example embodiment. Each operation of FIG. 6 is performed by the penalty imposition and management system 300 of FIG. 3, and each operation may be simplified or further divided by the penalty imposition and management system 300.

In operation S610, the penalty imposition and management system 300 registers the conditions of an advertising contract and penalty contents related to the conditions. Here, the registered conditions of the advertising contract may be stored together with contents of the advertising contract, for example, an advertising period and advertising cost. The conditions of the advertising contract may be divided into basic conditions in which the penalty is to be imposed and weighted conditions in which the penalty is to be weighted and thereby be imposed.

Also, in operation S610, the penalty imposition and management system 300 may store a history of contract conditions and a penalty for a breach of contract in a database 315 so as to be referred to if necessary and facilitate a management.

In operation S620, the penalty imposition and management system 300 monitors a fulfillment of the advertising contract, in order to determine an occurrence of the penalty to be imposed. In operation S620, when the monitoring is performed in real time or when an advertiser 210 of a target advertisement cancels the advertising contract, the penalty imposition and management system 300 identifies an input signal associated with cancellation of the advertising contract and then monitors whether the penalty is to be applied. In any case, when a signal for cancelling the advertising contract is received from the advertiser, the penalty imposition and management system 300 transfers a notification about the cancellation to the advertiser 210.

In operation S630, when a breach of advertising contract is recognized, the penalty imposition and management system 300 notifies contents of the penalty for the breach to the advertiser 210. Operation S630 may be performed with respect to the advertiser 210 of the target advertisement. Prior to notifying the penalty contents, the penalty imposition and management system 300 determines a method of applying the penalty contents, basic conditions, and weighted conditions.

Here, the penalty imposition and management system 300 may further include managing and referring to conditions of a target advertising contract and contents of a penalty. It is described above and thus, a further description will be omitted.

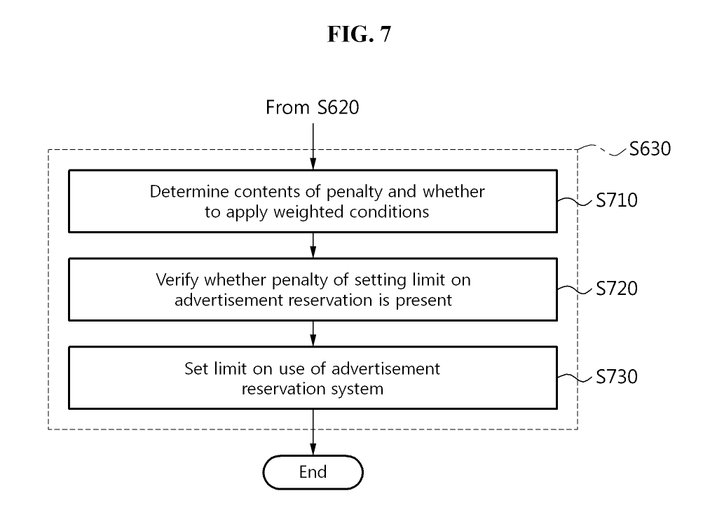

FIG. 7 is a flowchart illustrating an example of a method of determining an application of conditions in order to notify contents of a penalty for a breach of contract according to an example embodiment. Operations S710, S720, and S730 of FIG. 7 may be included in operation S630 of FIG. 6.

In operation S710, the penalty imposition and management system 300 determines contents of a penalty prepared in making the advertising contract, and also determines whether to apply basic conditions and weighted conditions.

In operation S720, the penalty imposition and management system 300 verifies whether a penalty of setting a limit on an advertisement reservation is present within conditions of the contract.

When the penalty of setting a limit on the advertisement reservation is present, the penalty imposition and management system 300 sets a limit on the corresponding advertiser using an advertisement reservation system in operation S730. On the contrary, when the penalty of setting a limit on the advertisement reservation is absent, the penalty imposition and management system 300 have no need to set a limit on the advertisement reservation.

As described above, as an example of applying a penalty for a breach of advertising contract, it is possible to set a limit on use of and access to the advertisement reservation system in interaction with the advertisement reservation system by determining whether to apply the penalty of setting a limit on the advertisement reservation.

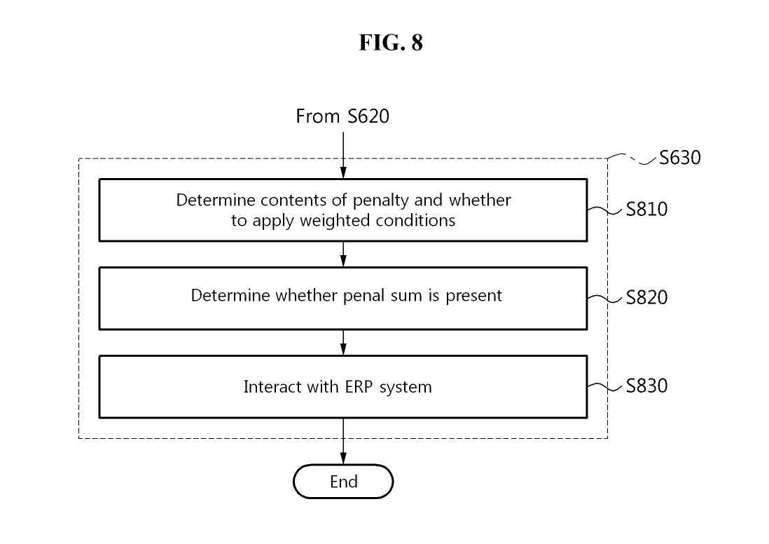

FIG. 8 is a flowchart illustrating another example of a method of determining an application of conditions in order to notify contents of a penalty for a breach of contract according to one example embodiment. Operations S810, S820, and S830 of FIG. 8 may be included in operation S630 of FIG. 6.

In operation S810, the penalty imposition and management system 300 determines whether to apply basic conditions and weighted conditions in order to determine whether contents of a penalty prepared in making the advertising contract is appropriate.

In operation S820, the penalty imposition and management system 300 determines whether a penal sum is present as a penalty for a breach of contract.

In operation S830, the penalty imposition and management system 300 interacts with an ERP system to more accurately and safely manage the penal sum.

Referring to FIGS. 7 and 8, the advertisement reservation system and the ERP system may be systems included in the individual advertisement platform 220 or the individual publisher 230, or may be separate systems associated with the individual advertisement platform or the individual publisher.

As described above, according to example embodiments, advertising contracts that are to be imposed with a penalty for a breach of contract may be managed without being omitted. Relevant contents may be registered to, stored in, and referred to using a system. Further, through interaction with a separate system, it is possible to decrease the occurrence of an error and safely manage the contents.

According to example embodiments, a system is provided that manages and verifies cases corresponding to a breach of contract by automatically registering, to a system, the cases to be imposed with a penalty for the breach of contract, and thereby preventing a case from being omitted in the course of tracking.

Also, according to example embodiments, in a case in which a breach of contract occurs, it is possible to register and store, to and in a system, matters related to an occurrence of a penalty and an imposition of the penalty, and to make it possible to refer to the registered matters.

Also, according to example embodiments, in a case in which a penalty for a breach of contract is imposed as a penal sum, it is possible to automatically interact with an ERP system, thereby preventing a transparency issue from arising in terms of managing the penal sum.

The example embodiments may be embodied and implemented in a computer having at least a processor and a non-volatile memory. The present invention may also be recorded in non-transitory computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may also act as one or more software modules in order to perform the operations of the above-described embodiments.

It will be apparent to those skilled in the art that various modifications and variation can be made in the example embodiments without departing from the spirit or scope of the invention. Thus, it is intended that the example embodiments cover the modifications and variations of this invention provided they come within the scope of the appended claims and their equivalents.

What is claimed is:

1. A system for imposing and managing a penalty for a breach of an advertising contract between an advertiser and an advertising platform in communication with the advertiser through a computer network, the system comprising:
a registration unit to register conditions of the advertising contract and penalty contents related to the conditions;
a monitoring unit to monitor a fulfillment of the advertising contract in order to determine whether the penalty is to be applied; and
a penalty unit to notify penalty contents related to the breach of the advertising contract when the breach of the advertising contract is recognized.

2. The system of claim 1, wherein the registration unit registers basic conditions of which the penalty is applied on the basis and weighted conditions of which the penalty is weighted on the basis, and stores a history of the basic conditions and the weighted conditions in a database.

3. The system of claim 1, wherein the monitoring unit monitors whether the penalty is to be applied in response to a request for cancelling the advertising contract, and automatically notifies a user of the system about a presence of conditions of which the penalty is to be applied on the basis.

4. The system of claim 1, wherein the penalty unit determines whether the penalty contents are to be applied, and notifies an advertiser of the advertising contract about an imposition of the penalty.

5. The system of claim 4, wherein the penalty unit limits an advertisement reservation in a case in which the penalty contents relate to limiting a subsequent advertisement publication, and interacts with an enterprise resources planning (ERP) system in a case in which the penalty contents relate to a payment of a penal sum of the advertising contract.

6. The system of claim 1, further comprising:
a management and reference unit to manage and refer to the conditions of the advertising contract and the penalty contents,
wherein the management and reference unit receives an input for modifying and cancelling the penalty contents related to the breach of the advertising contract.

7. A method of imposing and managing a penalty for a breach of an advertising contract between an advertiser and an advertising platform in communication with the advertiser through a computer network, the method comprising:
registering conditions of the advertising contract and penalty contents related to the conditions;
monitoring a fulfillment of the advertising contract in order to determine whether the penalty is to be applied; and
notifying penalty contents related to the breach of the advertising contract when the breach of the advertising contract is recognized.

8. The method of claim 7, wherein the registering comprises:
registering basic conditions of which the penalty is applied on the basis and weighted conditions of which the penalty is weighted on the basis; and
storing a history of the basic conditions and the weighted conditions in a database.

9. The method of claim 7, wherein the monitoring comprises:
monitoring whether the penalty is to be applied in response to a request for cancelling the advertising contract; and
automatically notifying a user of the system about a presence of conditions of which the penalty is to be applied on the basis.

10. The method of claim 7, wherein the notifying comprises:
determining whether the penalty contents are to be applied; and
notifying an advertiser of the advertising contract about an imposition of the penalty.

11. The method of claim 10, wherein the notifying comprises:
limiting an advertisement reservation in a case in which the penalty contents relate to limiting a subsequent advertisement publication; and
interacting with an enterprise resources planning (ERP) system in a case in which the penalty contents relate to a payment of a penal sum of the advertising contract.

12. The method of claim 7, further comprising:
managing and referring to the conditions of the advertising contract and the penalty contents,
wherein the managing and referring to comprises receiving an input for modifying the penalty contents related to the breach of the advertising contract and making a cancelation.
